(19) United States
(12) Patent Application Publication
(10) Pub. No.: US 2004/0159663 A1
(43) Pub. Date: Aug. 19, 2004

(54) Fuel tank and filler packet for dispersing ballistic shock

(76) Inventor: Ronald L. Fenton, Mt. Prospect, IL (US)

Correspondence Address: Douglas B. White, 1000 East Woodfield Road, Suite 102, Schaumburg, IL, 60173, US

(21) Appl. No.: 10/367,467

(22) Filed: Feb. 14, 2003

(51) Int. Cl. B60P 3/00; B62D 33/00; B65D 88/12

(52) U.S. Cl. 220/563

(57) ABSTRACT

An improved tank design incorporates a new filler packet insert. This filler packet is formed from a sheet of foil and exhibits in its unformed shape an expanded foil center and an unexpanded denser border. All of the edges of the foil sheet are then folded inwardly and the filler insert is finally rolled and secured to produce a cylindrical packet having a dense core. Once the fuel tank is filled with these packets, the ballistic shock is dissipated by the non-homogeneous mass of the tank volume.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates generally to tanks used for combustible materials and to explosion suppression devices for such tanks in the nature of filler elements or packets used to fill the tank. More particularly, this invention relates to a new design for such a filler packet which improves its effectiveness in maintaining tank integrity in the event of an impact and subsequent penetration by a ballistic body.

2. Description of the Prior Art

It is well known in the prior art that a filler mass insert or packet may be formed from expanded foil mesh and used as an insert within a tank to suppress explosion. These thermal inserts serve to absorb and transmit the heat encountered during a fire or explosion, to thereby eliminate hot spots on the tank that could result in the ignition of the tank contents. The typical prior art filler insert is formed of multiple layers of an expanded metal foil, as described in U.S. Pat. No. 3,356,256 and U.S. Pat. No. 4,921,118. The resulting filler mass can be either rolled into a coil, cut into pieces and stacked, or fan-folded, as described in U.S. Pat. No. 4,149,649 and U.S. Pat. No. 4,556,589, to produce a filler mass insert of the size and shape of the tank.

In order to provide protection from the impact of a bomb blast, there has been proposed in U.S. Pat. No. 5,563,364 that a tank wall be padded to absorb the shockwave of the blast. This anti-explosion pad is described as two sheets of expanded metal foil applied to the exterior of a tank wall and separated by a layer of balls also formed from expanded foil.

Although a padded wall provides limited absorption of the exterior shockwave from a bomb blast, when a tank is struck with a ballistic body, such as a bullet, this shock absorbing padding is easily penetrated. And in such a case, the ballistic body carries with it into the tank a powerful concentrated shockwave that ultimately causes the tank to disintegrate.

### SUMMARY OF THE INVENTION

Accordingly, it is the principal objective of this invention to present a new tank design which resists disintegration caused by a projectile.

It is a further objective to present a new thermal insert which serves to dissipate the thermal hot spots and suppress explosion, yet also serves to dissipate the ballistic shockwave accompanying a projectile.

It is yet another objective of the present invention to provide an insert packet and its method of manufacture which is both effective and economical.

The present invention provides a solution for the above noted vulnerability to the ballistic effect on the tank by providing a new filler packet insert and an improved tank design incorporating the new filler packet insert. This filler packet begins, in its unformed shape, with a foil sheet having an expanded foil center and an unexpanded denser border. All of the edges of the foil sheet are then folded inwardly and this folded packet is finally rolled to produce a cylindrical packet having a dense core. (Alternatively, a separate dense core may be inserted into a packet.)

A tank is filled with these filler packets to provide a fluid permeable tank volume having the dense centers of the filler packets dispersed throughout the tank. These spaced dense mass centers then serve to dissipate the ballistic shockwave accompanying the projectile.

### BRIEF DESCRIPTION OF THE DRAWINGS

FIG. 1 is a perspective view of a tank filled with filler packet inserts in accordance with the present invention.

FIG. 2 is a perspective of a completed filler packet in accordance with the present invention.

FIG. 3 is a perspective view of a sheet of partially expanded foil sheet for the manufacture of the filler packet in accordance with the present invention, showing an unexpanded and denser border area.

FIG. 4 is a perspective view of a sheet of partially expanded foil sheet for the manufacture of the filler packet, similar to FIG. 3, but with a border area on only two sides.

FIG. 5 is a cross sectional view of the sheet of FIG. 4 showing the folding construction technique.

FIG. 6 is a cross sectional view of the sheet of FIG. 4 showing further folding construction.

FIG. 7 is a perspective view of the sheet of FIG. 4 showing further folding construction.

FIG. 8 is a perspective view of the sheet of FIG. 4 showing the completion of the folding construction.

FIG. 8a is a perspective view of the sheet of FIG. 4 showing an alternative construction of the filler packet.

FIG. 9 is a cross sectional view of the filler packet of FIG. 8 rolled into a cylinder.

FIG. 9a is a cross sectional view of the packet of FIG. 8a showing the alternate construction of the filler packet.

While the invention will be described in connection with a preferred embodiment, it will be understood that it is not the intent to limit the invention to that embodiment. On the contrary, it is the intent to cover all alternatives, modifications, and equivalents as may be included within the spirit and scope of the invention as defined by the appended claims.

### DESCRIPTION OF THE PREFERRED EMBODIMENT

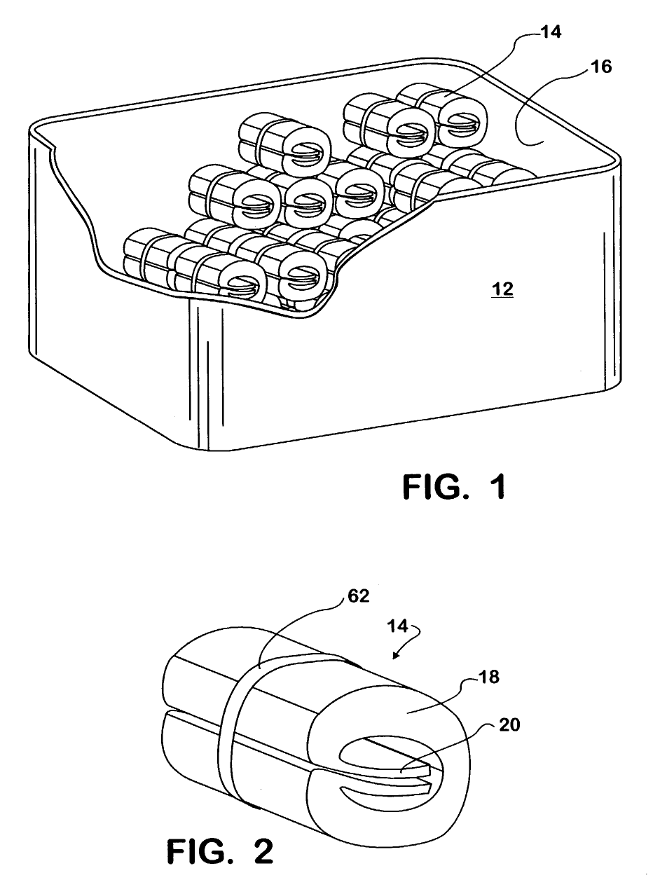

Turning first to FIG. 1 there is shown a tank 12 in accordance with the present invention having filler packets 14 filling the interior thereof. These packets are thermally conductive and positioned in thermal contact with the exterior walls 16 of the tank to thereby dissipate heat from the tank wall, as is now well known in the art. The individual packets 14 of the present invention (one embodiment of which is shown in FIG. 2) each exhibit a thermally conductive porous outer portion 18 for accommodating fuel within the tank and suppressing explosion by thermal conduction. For suppressing ballistic shock, an inner portion 20 is provided in each packet 14, which inner portion 20 has a greater mass density than the outer portion 18, as more fully described below.

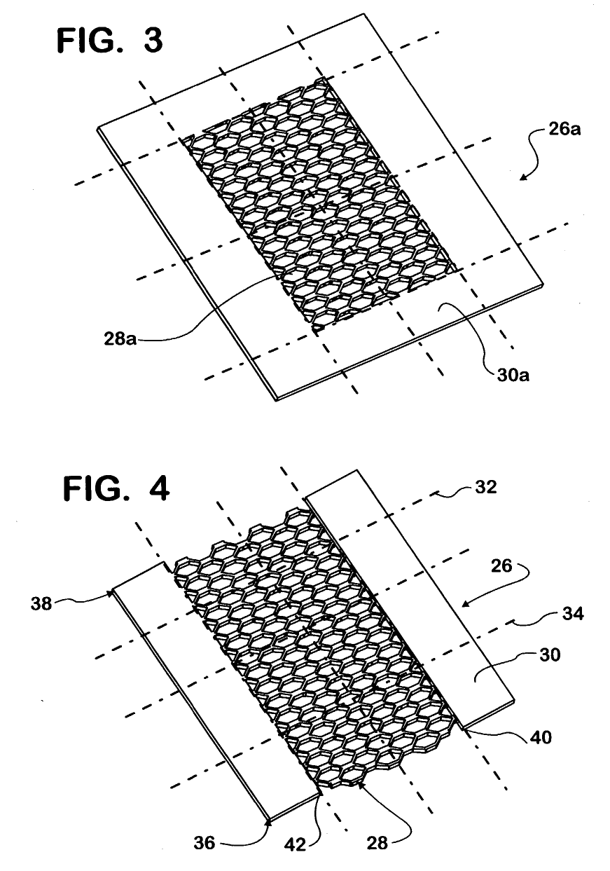

Formation of a filler packet in accordance with the preferred embodiment of the present invention begins with a sheet of expanded metal foil, the nature of which is well known to the art. In one embodiment, see FIG. 4, there is shown a sheet of metal foil 26, having an expanded center portion 28 and a defined outer border region 30 (on at least one side) of unexpanded foil to provide a border region of higher density. Similarly, in FIG. 3 there is shown a second embodiment of the initial foil sheet 26a for construction of the filler packet. In this second embodiment the border region 30a extends along all sides surrounding the expanded center region 28a. As equivalent alternatives, it should be apparent that the border region (in whole or in part) may comprise higher density material, multiple layers of the sheet, an additional layer of dense material, or any other equivalent means which serves to increase the mass density within that border region or ultimately in the center of the completed packet.

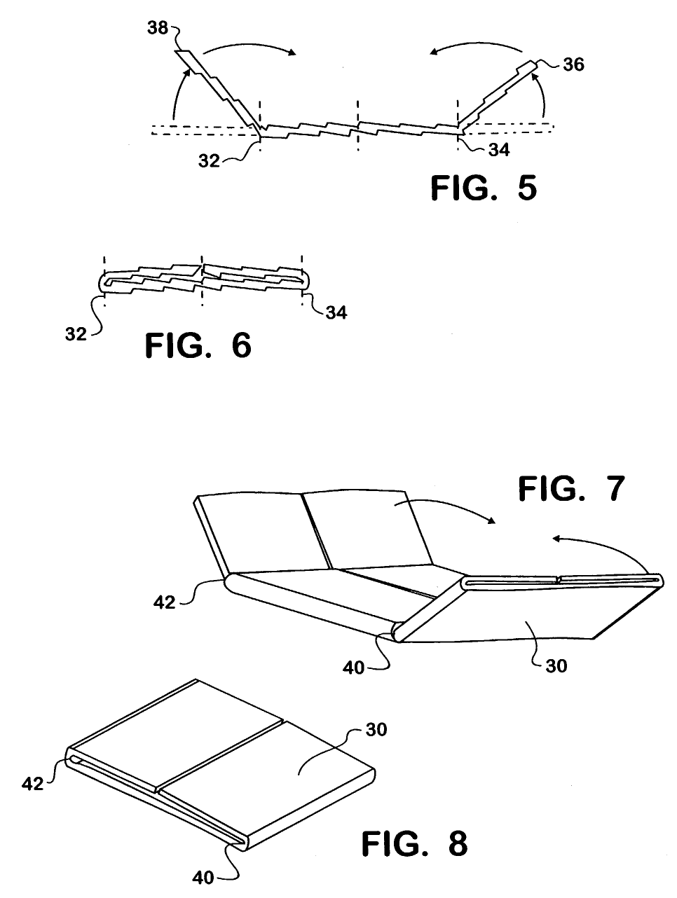

The construction of the filler element is shown in detail in the sequence depicted in FIGS. 5-8 and will be described with respect with the sheet of foil shown in FIG. 4, the construction with respect to the sheet of foil shown in FIG. 3 being identical thereto. The sheet is first bent or folded along lines 32 and 34 (FIGS. 5 and 6) to thereby cause the peripheral edges 36 and 38 to be positioned inwardly toward the center of the packet. This inward positioning of the peripheral edges 36 and 38 serves to place those cut free edges within the center of the filler packet to trap any pieces of the sheet that might break off and enter the fuel in the tank. In the embodiments where these edges carry dense border regions, those dense regions will also be placed near the center of the packet.

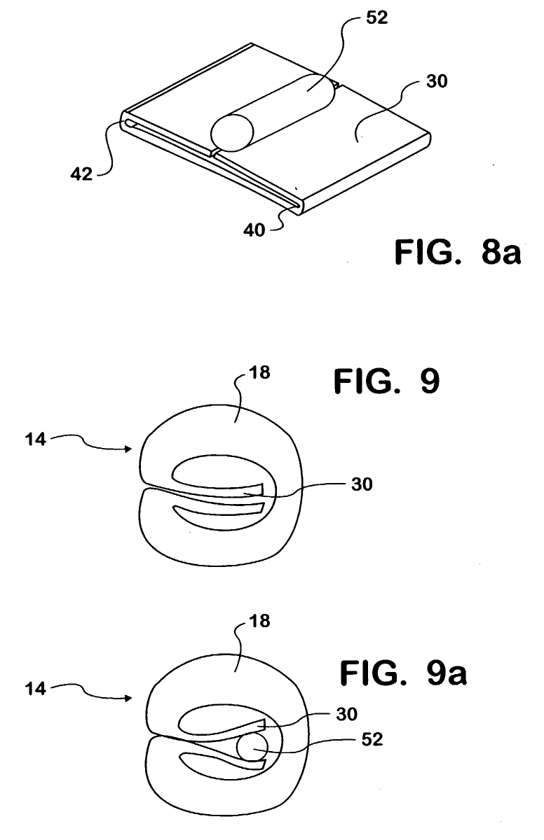

Next in the construction of the filler packet, the sides 30 bearing higher density border regions are bent or folded along lines 40 and 42 to position those dense regions (FIG. 7) within the center of the packet, as shown in FIG. 8. Alternatively or additionally, the filler packet at this stage of construction may have a dense member 52 placed in its center as shown in FIG. 8a, to produce or enhance the higher density center.

Finally, the flat intermediate folded member of FIG. 8 or FIG. 8a is rolled or otherwise formed into the completed cylindrical packet of FIG. 9 and FIG. 9a respectively. Once formed into the cylinder of FIG. 2, a band 62, or other equivalent means for securing the packet, is applied to secure the formed packet in its final shape during its insertion into the tank. The completed packet is shown in perspective in FIG. 2 and shown partially filling the tank in FIG. 1.

Once the tank is filled with the packets (the tank shown in FIG. 1 is only partially filled), the multitude of dense centers of the packets are broadly distributed throughout the volume of the tank, thereby presenting a non-homogenous internal volume with numerous dispersed dense mass concentrations. Alternatively, although it is preferred that all of these inserts present dense centers, it is within the scope of the invention that some, but not all, of the insert packets will have dense centers. Further, it is also within the scope of this invention that the insert packets could present centers of varying degrees of mass concentrations, and thereby accomplish the same purposes and objectives.

From the foregoing description, it will be apparent that modifications can be made to the apparatus and method for using same without departing from the teachings of the present invention. Accordingly, the scope of the invention is only to be limited as necessitated by the accompanying claims.

What is claimed is:

1. A filler packet for a fuel tank for dispersing ballistic shock comprising:
a body portion of fuel permeable material; and
a center portion exhibiting a higher density than said body portion.

2. The filler packet of claim 1 wherein said body portion comprises a sheet of expanded metal foil formed into a packet, wherein edges of said sheet are positioned near the center of said packet.

3. The filler packet of claim 2 wherein said sheet of metal foil further comprises a border region having an increased density, whereby said border region is positioned within said packet interior to provide said higher density in said center portion.

4. The filler packet of claim 1 wherein said center portion comprises a high density member positioned within said packet.

5. The filler packet of claim 1 wherein said body portion is thermally conductive.

6. The filler packet of claim 5 wherein said body portion comprises a sheet of expanded metal foil formed into a packet, wherein edges of said sheet are positioned near the center of said packet.

7. The filler packet of claim 6 wherein said sheet of metal foil further comprises a border region having an increased density, whereby said border region is positioned within said packet interior to provide said higher density in said center portion.

8. The filler packet of claim 5 wherein said center portion comprises a high density member positioned within said packet.

9. A tank for dispersing ballistic shock comprising:
an enclosure for containing the fuel;
filler packets positioned within said enclosure; and
wherein said filler packets comprise a body portion of fuel permeable thermally conductive material and a center portion exhibiting a higher density than said body portion.

10. The filler packet of claim 9 wherein said body portion comprises a sheet of expanded metal foil formed into a packet, wherein edges of said sheet are positioned near the center of said packet.

11. The filler packet of claim 10 wherein said sheet of metal foil further comprises a border region having an increased density, whereby said border region is positioned within said packet interior to provide said higher density in said center portion.

12. The filler packet of claim 9 wherein said center portion comprises a high density member positioned within said packet.

13. The filler packet of claim 9 wherein said body portion is thermally conductive.

14. The filler packet of claim 13 wherein said body portion comprises a sheet of expanded metal foil formed into a packet, wherein edges of said sheet are positioned near the center of said packet.

15. The filler packet of claim 14 wherein said sheet of metal foil further comprises a border region having an increased density, whereby said border region is positioned within said packet interior to provide said higher density in said center portion.

16. The filler packet of claim 13 wherein said center portion comprises a high density member positioned within said packet.

17. A method of constructing a ballistic shock dispersing filler packet for a tank comprising the steps of:
forming a sheet of expanded metal foil into a packet;
wherein said packet exhibits a body portion of fuel permeable thermally conductive material; and
a center portion exhibiting a higher density than said body portion.

18. The method of claim 17 wherein said sheet of metal foil further comprises a border region having an increased density, whereby said border region is positioned within said packet interior.

19. The method of claim 18 further comprising the step of forming said packet into a cylindrical shape and securing said packet.

20. The method of claim 17 wherein said center portion comprises a high density member placed within said packet.
